(19) United States
(12) Patent Application Publication
(10) Pub. No.: US 2008/0280484 A1
(43) Pub. Date: Nov. 13, 2008

(54) Power Converter for Battery Powered Devices

(76) Inventor: James Franklin Taylor, Humble, TX (US)

Correspondence Address: FRANK TAYLOR ATTORNEY AT LAW;A TEXAS PLLC, 6603 MAPLE DRIVE, HUMBLE, TX, 77338, US

(21) Appl. No.: 11/745,395

(22) Filed: May 7, 2007

(51) Int. Cl. H01R 3/00

(52) U.S. Cl. 439/500

(57) ABSTRACT

A device is disclosed herein for converting a battery powered device to electrical power without modifying the original device. The device is self-contained having the approximate shape and size of one of the batteries normally used The device comprises a DC power jack enclosed in the housing which connects two conductive terminals configured to match the shape and size of the battery's terminals. When two or more batteries are needed to power the device, dummy cells can be used to fill the battery compartment. A standard AC to DC converter can be plugged directly into the device without the need of additional equipment. Because the device accepts power from a standard AC to DC converter, it can be used to provide any output in voltage equal to that supplied by the plurality of batteries being replaced.

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to an external power device for battery powered items. More particularly, the present invention relates to a self-contained battery sized device that takes the place of a conventional battery that accepts the plug from a standard AC to DC power converter.

2. Description of the Related Art

Batteries are a very common power source for many devices such as radios, portable televisions, toys, hand-held games, and small appliances. Although many of these devices allow for both batteries and external power, many are still only powered by batteries. Additionally, the external power capabilities may cease functioning, leaving only a battery option. Battery powered devices have many advantages, such as their portable nature; however, they also have some disadvantages, such as the constant need to replace the batteries; not knowing how much time is left on the batteries; and the environmental hazards that batteries pose for landfills.

The prior art has attempted to address the disadvantages of battery powered devices. In most cases, battery sized devices have been designed to replace the batteries, but most have been hard wired with the power leads extruding from the device to some sort of external power transformer. Although these devices do provide external power, they are not simple enough for the non-electrically inclined and do not allow for the use of the readily available AC to DC power converters. AC to DC power converters have been used for several devices manufactured for use with such devices.

Accordingly, a need exists for a self-contained external power supply that can be easily installed and used with any standard AC to DC power converter. Additionally, the need exists for such a device that is also easy to manufacture.

### BRIEF SUMMARY OF THE INVENTION

The present invention comprises a device for providing power to a battery powered device through the use of a standard AC to DC power converter. The device comprises a substitute cell having a size and shape corresponding to that of the battery normally used. A DC power jack inserted into the housing of the device accepts a standard AC to DC power converter.

In use, a user may position the present invention in the battery powered device and, if more than one battery is needed, dummy cells can be used to fill the battery compartment. The location of the present invention does not matter as the dummy cells will complete the electrical connection. The user may then use a standard AC to DC converter to plug into the device and thus provide AC power output in voltage equal to that supplied by the plurality of batteries being replaced to the battery powered device.

One of the principle objectives of the present invention is to provide an alternative power source for a battery powered device.

Another objective of the present invention is to allow for the use of a common AC to DC power converter as the power source for the present invention.

Yet another objective of the present invention is to provide an alternative, external power source that is easy to manufacture and package.

Still another objective of the present invention is to provide an external power source that may be used in several different types of battery powered devices.

Yet another objective of the present invention is to provide an external power source that is easy to use and transfer between different battery powered devices.

These and other objectives will be apparent to those skilled in the art.

### BRIEF DESCRIPTION OF THE DRAWINGS

FIG. 1 is a sectional view of the present invention.

FIG. 2 is a top view of the present invention.

FIG. 3 is a sectional view of a dummy cell useful in conjunction with the present invention should the battery compartment normally bold more than one battery.

FIG. 4 is a perspective view of the present invention. Evident in this figure is the present invention and a battery powered device, the batteries of which have been removed and replaced with the present invention and two dummy cells to complete the circuit. The present invention is connected to a standard AC to DC power converter and plugged into a standard electrical outlet.

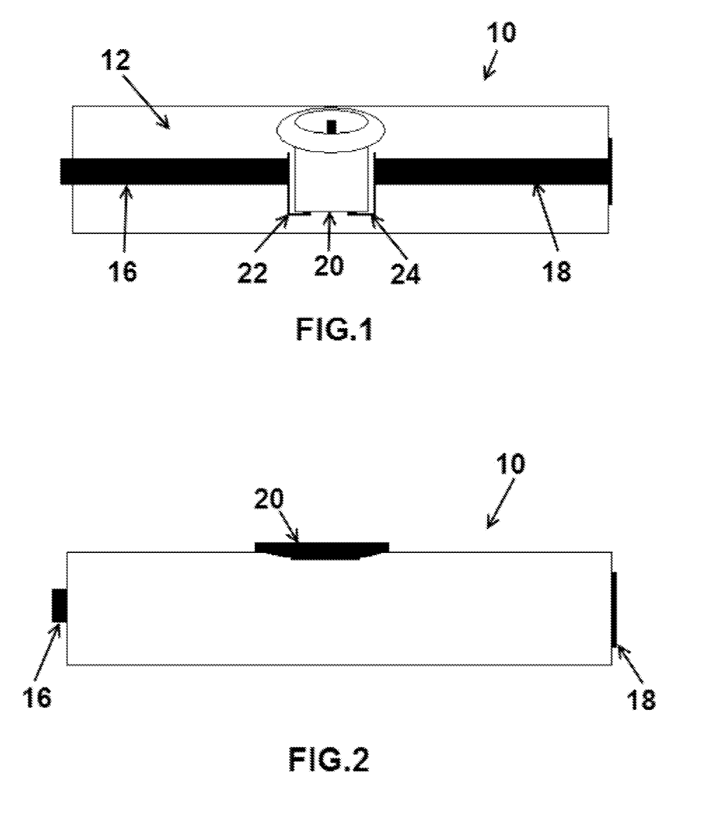

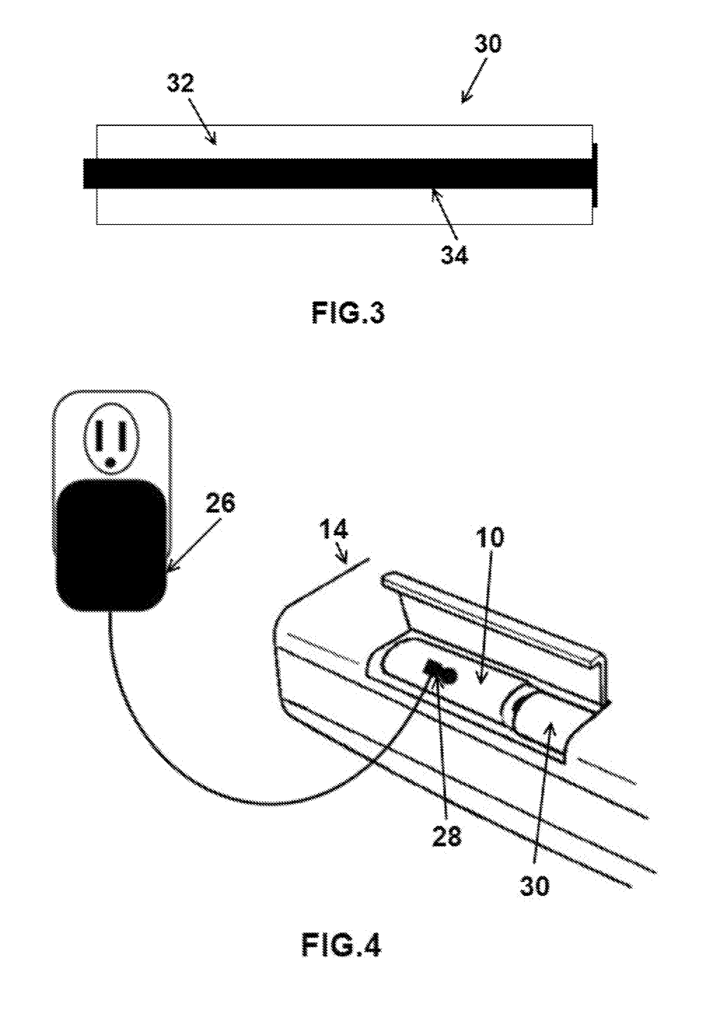

### DESCRIPTION OF THE PREFERRED EMBODIMENT

In accordance with the present invention, there is provided a device for supplying alternative power to a device normally operated by one or more batteries. The present invention is referred to as numeral 10. The present invention 10 comprises a battery shaped housing, 12. The battery shaped housing 12 may be shaped and sized to correspond to any standard battery size such as AA, C, D, or 9 Volt batteries. These examples are used for illustrative purposes only and it should be known that the present invention 10 can be provided with the shape of any battery that is required by the battery powered device 14. The present device 10 always having the positive 16 and negative 18 terminals sufficient to be used in substitution of the standard battery needed to power the battery powered device 14.

The present device 10 is further comprised of a positive 16 and negative 18 terminal and inserted into either end of the housing 12. These terminals 16 and 18 are made of a conductive material and manually connected to a DC power jack 20 which have extended positive 22 and negative 24 leads that allow for the manual connection. The DC power jack 20 is recessed into the housing 12 to ensure that the diameter of the present invention 10 is no larger than the battery normally used to power the battery powered device 14.

A standard AC to DC power converter 26 is then used to provide power to the present invention 10 through use of a DC power plug 28. Dummy cells 30 may then be used to fill the remaining space in the battery compartment of the battery powered device 14 if needed to complete the circuit.

The present device 10 is able to provide the equivalent power of the required batteries normally used in the battery powered device 14. A standard AC to DC power converter 26 with the appropriate size DC power plug 28 may be purchased at any electronics store.

The dummy cells 30 are comprised of a housing 32 similar in size and shape to the housing 12 of the present invention. A single conductive material 34 is inserted into the dummy cell housing 32 so that the ends of the dummy cell 30 are identical to those of the batteries being replaced. This allows for the power supplied through the present invention to reach the battery terminals of the battery powered device 14.

While the invention has been described with respect to several physical embodiments constructed in accordance therewith, it will be apparent to those skilled in the art that various modifications and improvements may be made without departing from the scope and spirit of the present invention. Accordingly, it is to be understood that the invention is not to be limited by the specific illustrative embodiments, but only by the scope of the appended claims. Furthermore nothing in the aforementioned description or preferred embodiment is to be interpreted as an admission by the applicant of prior art.

1. A self contained mechanical device for providing AC power to battery powered equipment, said invention comprising:
a plastic battery shaped housing to correspond to one of: a AA battery, a C battery, a D battery, a 9 volt battery, or any other standard size battery; and
two metal terminals inserted into the open ended housing in the shape and location of the terminals of one of the batteries normally required by the battery powered device; and
a two conductor DC power jack inserted into said housing, with one end of each conductor being connected without need of soldering or other electronic means, to a corresponding metal terminal.

2. The device defined in claim 1 further comprising:
a shape and size of the entire device no larger than one of the plurality of batteries that is required by the intended battery powered equipment; and of such a shape and size as can be easily inserted and removed from the battery compartment just as the battery it is meant to replace; and
a flush mounted DC power jack into which a standard AC to DC power converter may be easily and repeatedly plugged and unplugged; and
solid terminals extending from the housing and mechanically connected to the DC power jack.

3. A method of providing AC power to battery powered equipment through the use of a standard AC to DC power converter which is easily plugged and unplugged from the device to distribute power to corresponding positive and negative leads on the battery powered equipment through the device defined in claim 2.
